(19) United States
(12) Patent Application Publication
(10) Pub. No.: US 2024/0054525 A1
(43) Pub. Date: Feb. 15, 2024

(54) COMMODITY SALES DATA PROCESSING APPARATUS, COMPUTER-READABLE MEDIUM, AND METHOD OF PROCESSING COMMODITY SALES DATA

(71) Applicant: Toshiba Tec Kabushiki Kaisha, Tokyo (JP)

(72) Inventor: Hideyuki OOTA, Mishima Shizuoka (JP)

(21) Appl. No.: 18/360,703

(22) Filed: Jul. 27, 2023

(30) Foreign Application Priority Data
Aug. 9, 2022 (JP) 2022-127260

(51) Int. Cl. G06Q 30/0238; G06Q 30/0207

(52) U.S. Cl. CPC G06Q 30/0238; G06Q 30/0219

(57) ABSTRACT

A commodity sales data processing apparatus includes an input device, memory, and processor configured to: register for each commodity to be purchased information identifying the commodity and a number of units thereof, in response to an operation to select a target commodity, determine whether the registered number of units of the target commodity is less than or equal to a maximum number, upon determining that the registered number is less than or equal to the number, apply the coupon to all units of the target commodity, and upon determining that the registered number is greater than the number, in response to an operation to specify a number, determine whether the specified number is less than or equal to the maximum number, and upon determining that the specified number is less than or equal to the maximum number, apply the coupon to the specified number of units of the target commodity.

### CROSS-REFERENCE TO RELATED APPLICATION

This application is based upon and claims the benefit of priority from Japanese Patent Application No. 2022-127260, filed Aug. 9, 2022, the entire contents of which are incorporated herein by reference.

### FIELD

Embodiments described herein relate generally to a commodity sales data processing apparatus, a computer-readable medium, and a method of processing commodity sales data.

### BACKGROUND

Conventionally, in a store selling commodities, coupons offering rewards such as reductions or discounts on commodities are distributed as a service for promotion. In recent years, such coupons are distributed to smartphones in the form of code symbols such as bar codes, and the code symbols are read by a commodity sales data processing apparatus, such as a point-of-sale (POS) terminal, to give rewards. For example, there is a coupon (hereinafter also referred to as a quantity limited coupon) offering a discount on a limited number of units of a commodity, e.g., on only one unit of a commodity.

Further, in the commodity sales data processing apparatus described above, prior to the checkout process of commodities to be purchased by a customer, a registration process is performed to record (or register) information for identifying the commodities in association with the quantities of the commodities to be purchased. The registered commodities are displayed on a display unit of the commodity sales data processing apparatus together with the quantities of the commodities.

When using a coupon, the customer presents the coupon to an operator, such as a salesclerk, before the start of the checkout process. The operator inputs information indicating the coupon to the commodity sales data processing apparatus and selects a commodity (hereinafter, also referred to as a target commodity) to which the coupon is applied from among the commodities displayed on the display unit. As a result, the price of the target commodity is reduced or discounted.

However, with the conventional commodity sales data processing apparatus, there is a possibility that the quantity limited coupon cannot be appropriately used. For example, when a commodity, multiple units of which have been registered, is selected as a target commodity and a presented quantity limited coupon is applicable to a number of units less than the registered number of units of the target commodity, the number of units of the target commodity cannot be changed, and the coupon may be applied to all of the units of the target commodity.

### SUMMARY OF THE INVENTION

An embodiment of the present invention provides a commodity sales data processing apparatus capable of appropriately using a coupon that can be applied to a limited number of units of a commodity.

A commodity sales data processing apparatus comprises an input device; a memory; and a processor. The processor is configured to: register, in the memory and for each of commodities to be purchased, information for identifying the each of the commodities and a number of units of the each of the commodities in association with each other, in response to a first operation that is input through the input device to select a target commodity to which a coupon is to be applied from among the commodities, determine whether the registered number of units of the target commodity is less than or equal to a maximum number of units to which the coupon is applicable, upon determining that the registered number of units is less than or equal to the maximum number of units, apply the coupon to all of the units of the target commodity, and upon determining that the registered number of units is not less than or equal to the maximum number of units, in response to a second operation that is input through the input device to specify a number of units of the target commodity to which the coupon is to be applied, determine whether the specified number of units is less than or equal to the maximum number of units, and upon determining that the specified number of units is less than or equal to the maximum number of units, apply the coupon to the specified number of units of the target commodity.

### BRIEF DESCRIPTION OF THE DRAWINGS

FIG. 1 is a diagram illustrating a hardware configuration of a POS terminal according to an embodiment.

FIG. 2 is a diagram illustrating a functional configuration of the POS terminal.

FIG. 3 is a diagram illustrating a commodity registration screen displayed on a display unit of the POS terminal.

FIG. 4 is a diagram illustrating a commodity registration screen displayed on the display unit of the POS terminal.

FIG. 5 is a diagram illustrating an operation screen displayed on the display unit of the POS terminal.

FIG. 6 is a diagram illustrating a quantity specifying screen displayed on the display unit of the POS terminal.

FIG. 7 is a diagram illustrating a commodity registration screen displayed on the display unit of the POS terminal.

FIG. 8 is a diagram illustrating a transaction correction screen displayed on the display unit of the POS terminal.

FIG. 9 is a diagram illustrating a correction operation screen displayed on the display unit of the POS terminal.

FIG. 10 is a flowchart illustrating a commodity registration and checkout process performed by the POS terminal.

FIG. 11 is a flowchart illustrating a transaction correcting process performed by the POS terminal.

### DETAILED DESCRIPTION

Hereinafter, a commodity sales data processing apparatus and a computer-readable medium according to an embodiment are described with reference to the drawings. Hereinafter, a point-of-sale (POS) terminal 1 provided in a store, such as a supermarket, is described as an example of a commodity sales data processing apparatus. The present invention is not limited to the embodiments described below.

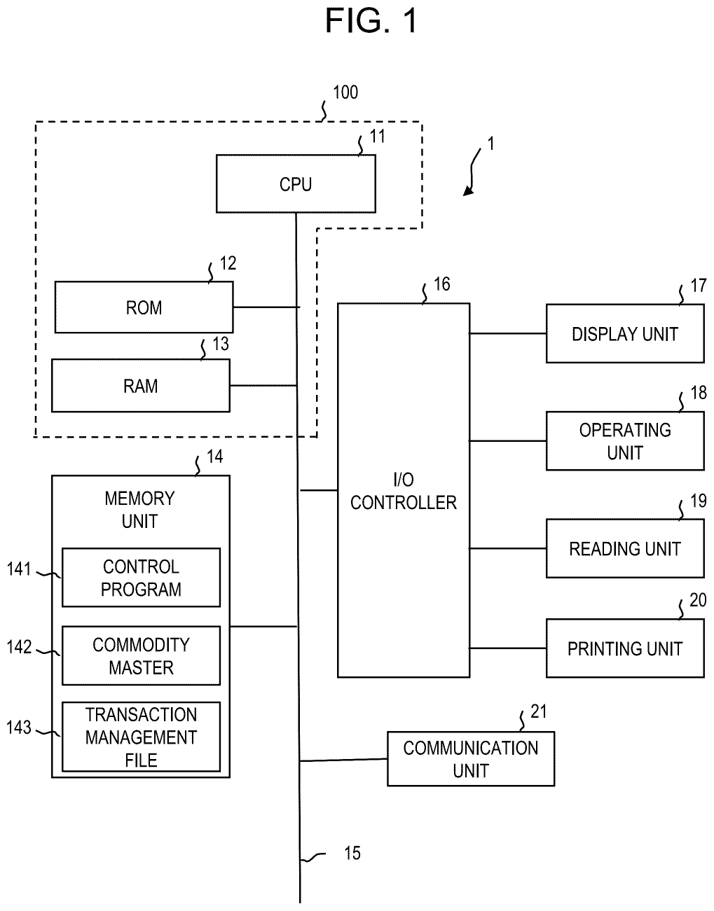

FIG. 1 is a diagram illustrating a hardware configuration of the POS terminal 1 according to an embodiment. As illustrated in FIG. 1, the POS terminal 1 includes a central processing unit (CPU) 11, a read-only memory (ROM)12, a random access memory (RAM)13, and a memory unit 14 that is a storage device. The CPU 11, the ROM 12, the RAM 13, and the memory unit 14 are connected to each other via a data bus 15. The CPU 11, the ROM 12, the RAM 13, and the memory unit 14 constitute a control unit or control circuit 100.

The CPU 11 controls the operation of the POS terminal 1. The ROM 12 stores programs defining processes executed by the CPU 11 and data required for the CPU 11 to execute various processes.

The RAM 13 stores, as needed, information necessary for the CPU 11 to execute various processes. For example, the RAM 13 stores image data representing an image to be displayed on a display unit 17. The RAM 13 is also used as a work area by the CPU 11 to execute various processes.

The memory unit 14 is a non-volatile memory, such as a hard disk drive (HDD) or a flash memory, that retains stored information even when the power is turned off. The memory unit 14 stores, for example, various control programs 141 that can be executed by the CPU 11 and various types of setting information.

The memory unit 14 stores a commodity master 142. The commodity master 142 is a master file that stores information on commodities sold at a store. For example, the commodity master 142 stores, for each commodity, commodity information including a commodity name and a unit price of the commodity in association with a commodity code. Here, the commodity code is an example of commodity identification information for identifying the type of a commodity. For example, a Japanese Article Number (JAN) code may be used as the commodity code. The commodity name is the name of the commodity. The unit price is the price of each piece or unit of the commodity.

The memory unit 14 stores a transaction management file 143. The transaction management file 143 is a data file for storing and managing transaction data indicating details of commodity registration and checkout processes performed by the POS terminal 1 for each transaction. For example, the transaction management file 143 stores transaction data of each transaction in association with a transaction number for identifying the transaction. The transaction data includes, for example, a commodity code, a commodity name, a unit price, a quantity (number of units), a discount value, and a subtotal price for each of commodities registered in the transaction, and information such as the total price of the commodities, a payment amount, and a change amount. The discount value and the subtotal price are described later.

An input/output (I/O) controller 16 for controlling input and output of data is connected to the data bus 15. The display unit 17, an operating unit 18, a reading unit 19, and a printing unit 20 are connected to the I/O controller 16.

The display unit 17 includes a display device such as a liquid crystal display (LCD). The display unit 17 displays various types of data under the control of the CPU 11. The operating unit 18 is an input device that includes, for example, a keyboard and a pointing device. The operating unit 18 outputs an instruction received from an operator, such as a salesclerk, to the CPU 11. The operating unit 18 may be a touch panel provided on a display screen of the display unit 17.

The reading unit 19 is a reading device capable of reading code symbols such as a bar code and a two-dimensional code. The reading unit 19 may be, for example, a reading device that reads code symbols using a laser or an imaging device that reads code symbols using an imaging element such as a charge coupled device (CCD) or a complementary metal oxide semiconductor (CMOS).

The reading unit 19 reads a commodity code for identifying a commodity from a code symbol attached to the commodity and outputs the read commodity code to the CPU 11. Further, the reading unit 19 reads coupon information from a coupon represented by a code symbol and outputs the read coupon information to the CPU 11. Here, a coupon may be displayed on a mobile terminal such as a smartphone carried by a customer or may be printed on a paper medium such as an advertisement or a receipt.

The coupon information includes, for example, information indicating a reward such as a discount amount or a discount rate. Also, coupon information of a coupon (hereinafter also referred to as a quantity limited coupon) applicable to a limited number of units of a commodity additionally includes quantity limiting information such as the maximum number of units of the commodity to which the coupon is applicable. Here, a coupon other than the quantity limited coupon may also be referred to as a quantity limited coupon that is applicable to an unlimited number of units of a commodity.

The printing unit 20 is a printing apparatus such as a thermal printer. Under the control of the CPU 11, the printing unit 20, for example, prints a receipt indicating the content of a transaction at the end of the checkout process.

A communication unit 21 is connected to the data bus 15. For example, the communication unit 21 is a network interface circuit that communicates with external devices such as a host server and various peripheral devices via a communication line (not shown).

The hardware configuration of the POS terminal 1 is not limited to that shown in FIG. 1. For example, the POS terminal 1 may include, for example, a change machine capable of accepting banknotes and coins and giving change. In addition, the POS terminal 1 may include a credit payment device capable of processing credit-card payment. In addition, the POS terminal 1 may include a reader/writer capable of reading data from an IC tag included in, for example, a contactless electronic money card.

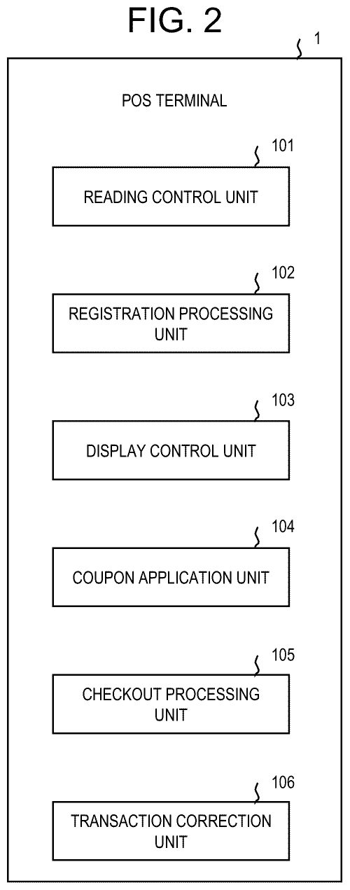

Next, referring to FIG. 2, a functional configuration of the POS terminal 1 is described. FIG. 2 is a diagram illustrating a functional configuration of the POS terminal 1. As illustrated in FIG. 2, the POS terminal 1 includes a reading control unit 101, a registration processing unit 102, a display control unit 103, a coupon application unit 104, a checkout processing unit 105, and a transaction correction unit 106 as functional components.

Specifically, the control unit 100 or the CPU 11 of the POS terminal 1 implements the above-described functional components by executing the control programs 141 stored in the memory unit 14. In the present embodiment, the above-described functional components are software components implemented by cooperation between a processor and programs of the POS terminal 1. However, the present invention is not limited to this example, and some or all of the hardware components may be implemented by, for example, dedicated circuits.

The reading control unit 101 is an example of a reading unit. The reading control unit 101 reads information from a code symbol in cooperation with the reading unit 19. For example, the reading control unit 101 reads a commodity code from a code symbol attached to a commodity. Further, the reading control unit 101 reads coupon information from a code symbol representing a coupon.

The registration processing unit 102 is an example of a registration unit. The registration processing unit 102 executes a process of registering a commodity purchased by the customer. Specifically, when a commodity code is read by the reading control unit 101, the registration processing unit 102 reads commodity information of a commodity corresponding to the commodity code from the commodity master 142, and registers (stores) the read commodity information in the RAM 13 as registration data together with, for example, the commodity code and a quantity (number of units).

Here, the quantity indicates the number of commodities corresponding to the same commodity code (or the number of units of the same commodity) and is managed in units of registration data. For example, the quantity is input via the operating unit 18 when a commodity code is read. Further, the quantity may be counted by the registration processing unit 102 by incrementing the quantity associated with a commodity code by one each time a commodity with the same commodity code is read. It is assumed that the default value of the quantity is 1.

The display control unit 103 is an example of a display control unit. The display control unit 103 controls a screen to be displayed on the display unit 17. Specifically, the display control unit 103 causes the display unit 17 to display various screens for supporting the operation of the POS terminal 1 in cooperation with other functional components. For example, the display control unit 103 causes the display unit 17 to display a screen showing, for example, a commodity name, a quantity (number of units), and a price of each registered commodity based on registration data registered by the registration processing unit 102. Further, for example, the display control unit 103 causes the display unit 17 to display various screens related to transactions of commodities in cooperation with the coupon application unit 104, the checkout processing unit 105, and the transaction correction unit 106.

The coupon application unit 104 is an example of a first reception unit, an application unit, and a second reception unit. The coupon application unit 104 executes a process related to application of a coupon. Specifically, when coupon information is read by the reading control unit 101, the coupon application unit 104 applies a reward such as a discount amount or a discount rate specified by the coupon information to the target commodity.

For example, when the reward included in the coupon information specifies a discount amount, the coupon application unit 104 subtracts the discount amount specified in the coupon information from the unit price of a commodity to which the coupon is to be applied. Further, for example, when the reward included in the coupon information specifies a discount rate, the coupon application unit 104 subtracts, from the unit price of a commodity to which the coupon is to be applied, an amount derived by multiplying the unit price of the commodity by the discount rate.

Further, in the present embodiment, it is assumed that a commodity to which a coupon is to be applied is selected by an operator. An operator selects a commodity (hereinafter also referred to as a target commodity) to which a coupon is to be applied from among registered commodities based on information that indicates, for example, a commodity name of the target commodity and is displayed together with the code symbol of the coupon. In this case, for example, when the coupon information is read by the reading control unit 101, the coupon application unit 104 cooperates with the display control unit 103 to cause the display unit 17 to display a screen on which the target commodity can be selected from the registered commodities. When the target commodity is selected by the operator, a reward such as a discount amount or a discount rate specified in the coupon-information is applied to the target commodity. Hereinafter, applying a reward specified in coupon information is also referred to as “applying a coupon”.

For example, when a quantity limited coupon is presented from a customer and a commodity multiple units of which have been registered is selected as a target commodity, the coupon application unit 104 compares the registered number of units of the target commodity with an applicable number of units that is specified in the coupon information of the quantity limited coupon and to which the quantity limited coupon is applicable, and determines whether the registered number of units of the target commodity is less than or equal to the applicable number of units. Here, when the registered number of units of the target commodity is less than or equal to the applicable number of units, the coupon application unit 104 applies the coupon to all of the units of the target commodity.

On the other hand, when the registered number of units of the target commodity is greater than the applicable number of units, the coupon application unit 104 causes the display unit 17 to display a screen for specifying a number of units of the target commodity to which the coupon is applied by cooperating with the display control unit 103. When the operator specifies a number of units less than or equal to the applicable number of units, the coupon application unit 104 applies the coupon to the specified number of units of the target commodity.

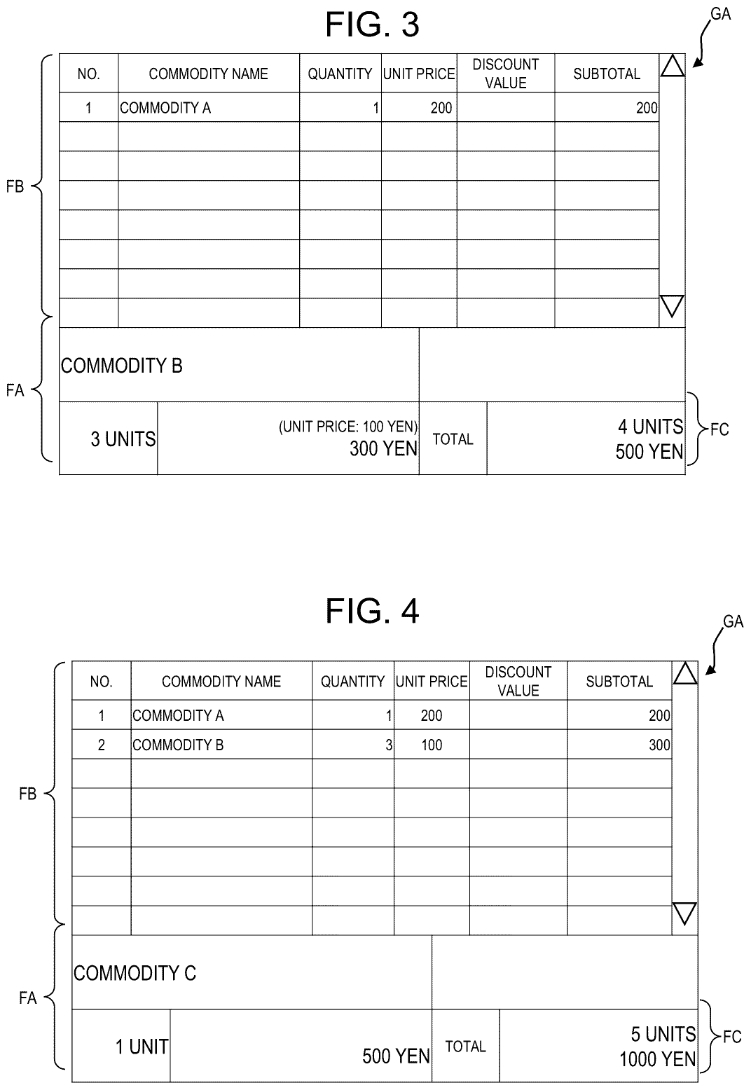

Hereinafter, an operation example of the above-described coupon application unit 104 is described with reference to FIGS. 3 to 7. FIG. 3 and FIG. 4 are diagrams illustrating exemplary commodity registration screens displayed on the display unit 17 of the POS terminal 1. As illustrated in FIGS. 3 and 4, a commodity registration screen GA includes a first display area FA, a second display area FB, and a third display area FC.

The first display area FA is an area for displaying information about a commodity registered most recently. Specifically, in the first display area FA, a commodity name, a quantity (number of units), a unit price, and a subtotal price of the registered commodity are displayed. The subtotal price means the total price of one or more units of a commodity registered in each set of registration data. For example, the subtotal price of a commodity whose discount value is zero (empty) can be obtained by multiplying the unit price of the commodity by the quantity. On the other hand, the subtotal price of a commodity for which a discount value is set can be obtained by multiplying a unit price, which has been discounted based on the discount value, by the quantity. The discount value is an example of information indicating whether a coupon is applied.

The second display area FB displays a list of registered commodities. Similarly to the first display area FA, the second display area FB has display fields for displaying the commodity name, the quantity, the unit price, the discount value, and the subtotal price of each registered commodity. In the “discount value” field displays a discount amount (Japanese yen) or a discount rate (%) applied to the unit price of the commodity displayed. A “No.” field displays a value indicating the order in which data is registered.

FIG. 3 illustrates a state in which after a commodity A displayed in the “No. 1” row of the second display area FB is registered, a commodity B displayed in the first display area FA is registered. Then, when a commodity C is registered, as shown in FIG. 4, the information on the commodity B displayed in the first display area FA of FIG. 3 is moved to the “No. 2” row of the second display area FB, and the information on the newly registered commodity C is displayed in the first display area FA. The timing when information is moved from the first display area FA to the second display area FB is not limited to the timing when a new commodity is registered. For example, information may be moved from the first display area FA to the second display area FB in response to an operation of, for example, a subtotal button (not shown).

The third display area FC displays the total number of units and the total price of the registered commodities. The calculation of the total number of units and the total price may be performed by the registration processing unit 102 or by another functional unit such as the display control unit 103.

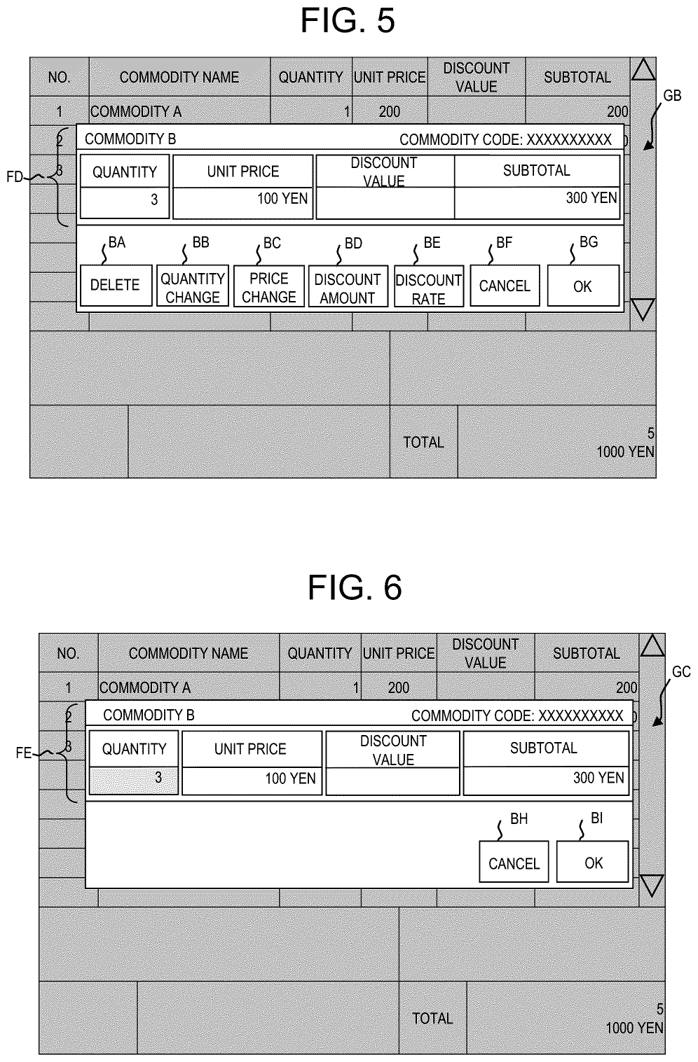

Here, for example, when a coupon is to be applied to the commodity B displayed in the “No. 2” row in the second display area FB” in FIG. 4, the operator selects the commodity B as a target commodity from the second display area FB. When receiving an operation to select the commodity B, as illustrated in FIG. 5, the display control unit 103 causes the display unit 17 to display an operation screen GB for receiving an operation related to the registered information of the commodity B.

FIG. 5 is a diagram illustrating the operation screen GB displayed on the display unit 17 of the POS terminal 1. As illustrated in FIG. 5, the operation screen GB includes a display area FD in which a commodity name (commodity B), a commodity code (XXXXXXXXXX), a quantity (number of units), a unit price, a discount value, and a subtotal price are displayed as the registered information of the commodity. The operation screen GB includes various operation elements such as a “delete” button BA, a “quantity change” button BB, a “price change” button BC, a “discount amount” button BD, a “discount rate” button BE, a “cancel” button BF, and an “OK” button BG.

Here, the “delete” button BA is used to cancel registration. When the “delete” button BA is operated, the registration processing unit 102 deletes the registration data of the target commodity.

The “quantity change” button BB is used to change the quantity. When the “quantity change” button BB is operated, the registration processing unit 102 cooperates with the display control unit 103 to make the quantity (or the number of units) of the target commodity changeable. When a changed quantity is input, the registration processing unit 102 recalculates the subtotal price based on the changed quantity and updates the screen.

The “price change” button BC is used to change the unit price. When the “price change” button BC is operated, the registration processing unit 102 cooperates with the display control unit 103 to make the unit price of the target commodity changeable. When a changed unit price is input, the registration processing unit 102 recalculates the subtotal price based on the changed unit price and updates the screen.

The “discount amount” button BD and the “discount rate” button BE are used to directly specify a discount amount and a discount rate, respectively. When the “discount amount” button BD or the “discount rate” button BE is operated, the registration processing unit 102 cooperates with the display control unit 103 to enable entry (or change) of a value in the “discount value” field of the target commodity. Then, the registration processing unit 102 recalculates the subtotal price based on an input discount amount or discount rate, and updates the second display area FB.

The “cancel” button BF is used to cancel the selection of the commodity. When the “cancel” button BF is operated, the display control unit 103 clears the operation screen GB and returns the display to the original screen. The “OK” button BG is used to apply a change operation. When the “OK” button BG is operated, the registration processing unit 102 applies changes made to the registered information through the operation of the buttons BB-BE to the record of the target commodity. Further, the registration processing unit 102 updates the subtotal price of the target commodity based on the changed registered information, and updates the total price of the entire transaction.

When applying a coupon, the operator of the POS terminal 1 causes the reading unit 19 to read the code symbol of the coupon after selecting a target commodity on the operation screen GB. When coupon information is read from the code symbol of the coupon, the coupon application unit 104 determines whether quantity limiting information for limiting the number of units of the commodity is specified in the coupon information. When the quantity limiting information is not specified, the coupon application unit 104 applies the coupon to all units of the target commodity, and returns the display to the commodity registration screen GA. In this case, in the “discount value” field of the target commodity displayed in the second display area FB, the discount amount or the discount rate of the applied reward is displayed.

When the maximum number of units is specified in the coupon information read from the coupon, that is, when a quantity limited coupon is read, the coupon application unit 104 compares the registered number of units of the target commodity with the maximum number of units specified in the coupon information, and determines whether the registered number of units of the target commodity is less than or equal to the maximum number of units. Here, when the registered number of units of the target commodity is less than or equal to the maximum number of units, the coupon application unit 104 applies the coupon to all units of the target commodity, and returns the display to the commodity registration screen GA. In this case, in the “discount value” field of the target commodity displayed in the second display area FB, the discount amount or the discount rate of the applied reward is displayed.

On the other hand, when the registered number of units of the target commodity is greater than the maximum number of units, the coupon application unit 104 cooperates with the display control unit 103 to cause the display unit 17 to display a quantity specifying screen GC illustrated in FIG. 6.

FIG. 6 is a diagram illustrating the quantity specifying screen GC displayed on the display unit 17 of the POS terminal 1. As illustrated in FIG. 6, the quantity specifying screen GC includes a display area FE for displaying the same information as the display area FD.

Here, the value in the “quantity” field of the display area FE can be changed by using the operating unit 18. The operator inputs the number of units of the target commodity to which the coupon is to be applied in the “quantity” field based on the maximum number of units specified in the quantity limited coupon. The display control unit 103 may cooperate with the coupon application unit 104 to limit the number of units that can be input to a value less than or equal to the maximum number of units.

Further, the quantity specifying screen GC includes various operation elements (buttons) such as “cancel” and “OK”. The “cancel” button BH is used to cancel the application of the coupon (quantity limited coupon). When the “cancel” button BH is operated, the display control unit 103 clears the quantity specifying screen GC and returns the display to the commodity registration screen GA.

The “OK” button BI is used to set the value entered in the “quantity” field as the number of units of the commodity to which the coupon is to be applied. When the “OK” button BI is operated, the coupon application unit 104 applies a reward such as a discount amount or a discount rate specified in the coupon information to one or more units of the target commodity corresponding to the value entered in the “quantity” field, and returns the display to the commodity registration screen GA. The display control unit 103 may cooperate with the coupon application unit 104 to disable the “OK” button BI to prevent its operation until a value less than or equal to the maximum number of units is entered in the “quantity” field.

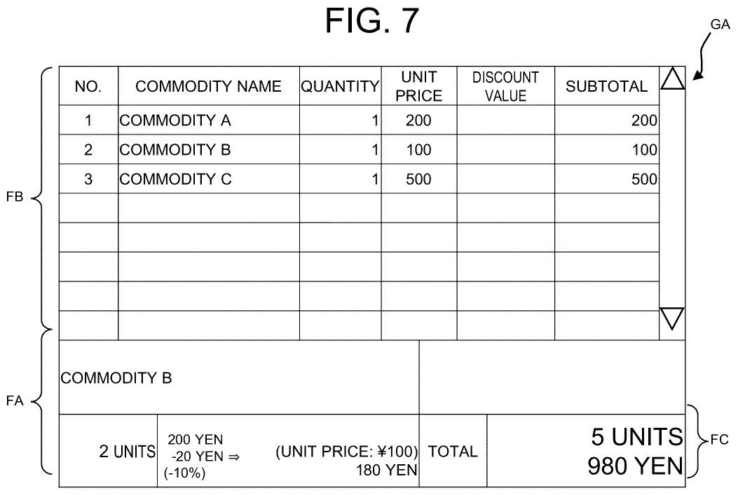

FIG. 7 is a diagram illustrating a commodity registration screen GA displayed on the display unit 17 of the POS terminal 1. Here, FIG. 7 shows a state of the commodity registration screen GA that is displayed when “2” is specified on the quantity specifying screen GC illustrated in FIG. 6 as the number of units of the target commodity to which the coupon is to be applied.

As shown in the commodity registration screen GA of FIG. 7, as a result of the operation on the quantity specifying screen GC, information on the target commodity to which the coupon is to be applied is displayed in the first display area FA. More specifically, the quantity “2” entered in the “quantity” field of the quantity specifying screen GC, information indicating a discount amount or a discount rate applied by the coupon, and information indicating how the discount amount or rate is applied are displayed in the first display area FA together with other information such as the commodity name “commodity B”. In other words, the first display area FA displays information regarding coupon-applied units of the target commodity to which the coupon has been applied among all the units of the commodity B selected as the target commodity.

Further, in the second display area FB, the quantity “3” of the commodity B (target commodity) in FIG. 4 has been changed to “1” based on the value specified in the “quantity” field of the quantity specifying screen GC. More specifically, the second display area FB displays information regarding a coupon-not-applied unit to which the coupon is not applied among multiple units of the commodity B selected as the target commodity. That is, the display control unit 103 separately displays a coupon-applied unit(s) and a coupon-not-applied unit(s) on the commodity registration screen GA. With this configuration, the operator of the POS terminal 1 can easily confirm registered information on coupon-applied units to which the coupon is applied among multiple units of the target commodity. In addition, the operator of the POS terminal 1 can easily confirm registered information on coupon-not-applied units to which the coupon is not applied among multiple units of the target commodity. Note that the display control unit 103 may perform display control such that the display field of coupon-not-applied units is highlighted to facilitate comparison with coupon-applied units.

As described above, the coupon application unit 104 applies a reward specified in a coupon to a target commodity in response to the reading of the coupon. In addition, when the coupon is a quantity limited coupon, the coupon application unit 104 applies the reward specified in the coupon to the target commodity within the quantity specified in the quantity-limited coupon.

It is assumed that the registration processing unit 102 performs registration (reregistration) of a commodity to which a coupon is applied by cooperating with the coupon application unit 104. Specifically, the registration processing unit 102 registers, as a discount value, information indicating a discount amount or a discount rate in the registration data of a commodity for which the discount amount or the discount rate is set by the application of a coupon. In addition, in response to an operation on the quantity specifying screen GC, the registration processing unit 102 divides the registration data of the target commodity into registration data of coupon-applied units and registration data of coupon-not-applied units and reregisters the sets of the registration data. For example, the registration processing unit 102 separates registration data of coupon-applied units from the registration data of the target commodity, and registers the separated registration data as new registration data.

Returning to FIG. 2, the checkout processing unit 105 is an example of a checkout unit. The checkout processing unit 105 calculates the total price of commodities based on transaction data registered in the RAM 13 or the like. Specifically, the checkout processing unit 105 calculates the total price of commodities pertaining to one transaction from transaction data of the commodities registered so far in response to a checkout operation for starting a checkout process.

In addition, the checkout processing unit 105 executes a checkout process of settling the calculated total price with the amount of money (hereinafter referred to as a payment amount) paid by the customer. Any payment method such as cash, credit-card payment, and code payment can be used. Note that the checkout processing unit 105 may cause the display unit 17 to display a screen for selecting a payment method for the checkout process.

When the checkout process is completed, the checkout processing unit 105 stores transaction data indicating the details of the transaction in a transaction management file 143 in association with a transaction number for identifying the transaction. Here, the transaction data includes, for example, commodity codes, commodity names, unit prices, quantities (numbers of units), subtotal prices, discount values, a total quantity, and a total price of commodities registered in the transaction, and information such as a payment amount, a change, and a payment method. When the checkout process is completed, the checkout processing unit 105 issues a receipt on which the transaction number and the transaction details are printed from the printing unit 20.

The receipt issued from the printing unit 20 is handed to the customer by the operator of the POS terminal 1. Note that, although a receipt printed on a paper medium is provided to the customer in the present embodiment, the present invention is not limited to this example, and an electronic receipt may be provided to the customer. In this case, for example, during a transaction, customer identification information (for example, a member number) for identifying a customer is input to the POS terminal 1. When the checkout process is completed, the checkout processing unit 105 transmits an electronic receipt including a transaction number and data indicating transaction details to a destination such as a prestored email address corresponding to the customer identification information.

The transaction correction unit 106 executes a process for correcting the registered information of the transaction for which the checkout process has been completed. Specifically, when the transaction number of a transaction to be corrected is input, the transaction correction unit 106 reads the transaction data corresponding to the transaction number from the transaction management file 143. Then, the transaction correction unit 106 cooperates with the display control unit 103 to cause the display unit 17 to display a transaction correction screen for correcting the read transaction data, and executes a correction process in response to an operation performed by the operator.

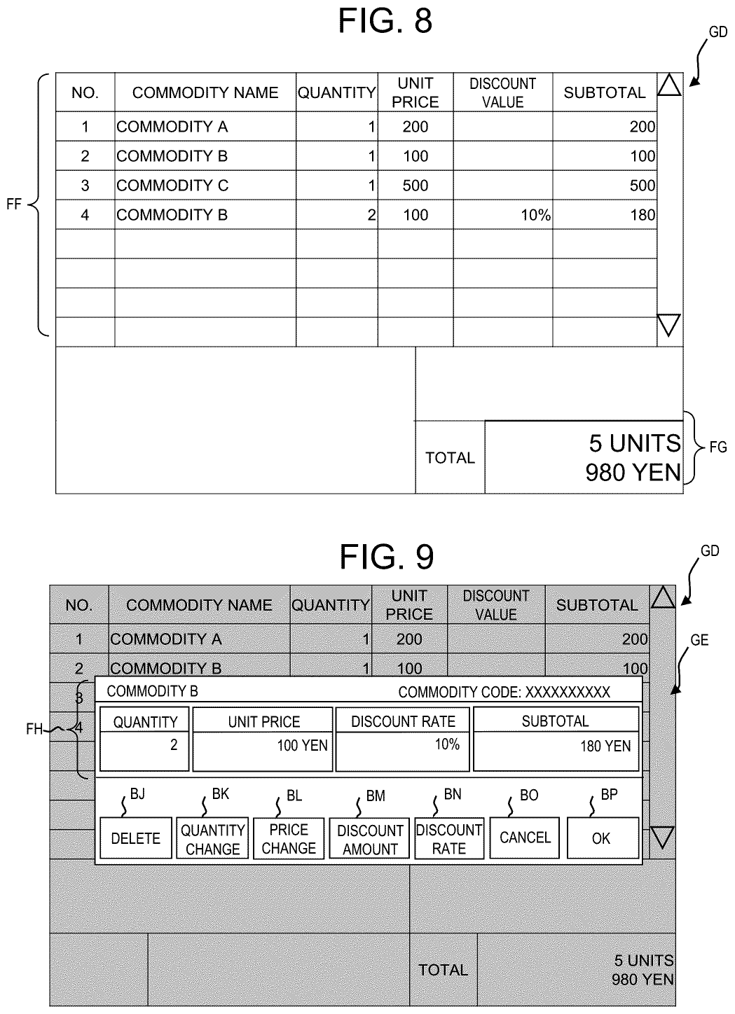

Hereinafter, an example of an operation of the transaction correction unit 106 is described with reference to FIGS. 8 and 9. FIG. 8 is a diagram illustrating a transaction correction screen displayed on the display unit 17 of the POS terminal 1. As illustrated in FIG. 8, a transaction correction screen GD includes a first display area FF and a second display area FG.

The first display area FF is an area for displaying information about commodities registered in a transaction with a designated transaction number. Specifically, in the first display area FF, the commodity names, the quantities (numbers of units), the unit prices, the discount values, the subtotal prices, and the like of the registered commodities are displayed. The second display area FG is an area for displaying the total quantity (number of units) and the total price of the commodities registered in the transaction with the designated transaction number.

When correcting the transaction information, the operator of the POS terminal 1 selects a commodity (hereinafter referred to as a correction target commodity) the transaction data of which is to be corrected from the first display area FF. When the correction target commodity is selected, the transaction correction unit 106 causes the display unit 17 to display a correction operation screen for correcting the transaction information of the correction target commodity in cooperation with the display control unit 103. For example, when a commodity (for example, the commodity B in the No. 4 row of FIG. 8) that has been discounted by the application of the coupon is selected as the correction target commodity, the transaction correction unit 106 causes the display unit 17 to display a correction operation screen illustrated in FIG. 9.

FIG. 9 is a diagram of a correction operation screen displayed on the display unit 17 of the POS terminal 1. As illustrated in FIG. 9, a correction operation screen GE includes a display area FH in which a commodity name (commodity B), a commodity code (XXXXXXXXXX), a quantity (number of units), a unit price, a discount value, a subtotal price, and the like are displayed as the registered information of the correction target commodity. Further, the correction operation screen GE includes various operation elements such as a “delete” button BJ, a “quantity change” button BK, a “price change” button Bl, a “discount amount” button BM, a “discount rate” button BN, a “cancel” button BO, and an “OK” button BP. The functions of the respective operation elements are the same as those of the buttons BA-BG on the operation screen GB described with reference to FIG. 5, and the transaction correction unit 106 receives instructions to correct the transaction information via various buttons.

For example, when a coupon is applied due to an erroneous operation, the operator of the POS terminal 1 operates the “discount amount” button BM or the “discount rate” button BN. When receiving the operation of the “discount amount” button BM or the “discount rate” button BN, the transaction correction unit 106 makes the value in the “discount value” field changeable. When “0” is entered in the “discount value” field and the “OK” button BP is operated, the transaction correction unit 106 corrects the state of the correction target commodity to a state in which the coupon is not applied, i.e., to a state in which the correction target commodity is not discounted. Specifically, the transaction correction unit 106 calculates the subtotal price of the correction target commodity without applying a discount to the correction target commodity, and updates the total price based on the calculation result.

Further, for example, when correcting the number of units of the commodity to which the coupon is applied, the operator of the POS terminal 1 operates the “quantity change” button BK. When receiving the operation of the “quantity change” button BK, the transaction correction unit 106 makes the value in the “quantity” field changeable. When the value in the “quantity” field is changed and the “OK” button BP is operated, the transaction correction unit 106 corrects the number of units of the correction target commodity to which the coupon is applied, that is, the number of units of the commodity to be discounted, based on the changed quantity.

When the number of units of the correction target commodity to be discounted increases or decreases as a result of the change of the “quantity” on the correction operation screen GE, the transaction correction unit 106 increases or decreases the number of units of the corresponding commodity displayed in the display area FH. Specifically, when the “quantity” is changed, the transaction correction unit 106 increases or decreases the number of units (or the number of coupon-applied units) of the correction target commodity to which the discount (or the coupon) is applied and the number of units (or the number of coupon-not-applied units) of the commodity that has the same commodity code as the correction target commodity and to which the discount (or the coupon) “ ”is not applied.

As described above, the transaction correction unit 106 executes the correction process related to the application of the coupon based on the instruction from the operator. After the completion of the correction process, the transaction correction unit 106 causes the printing unit 20 to issue a corrected receipt indicating the corrected transaction information.

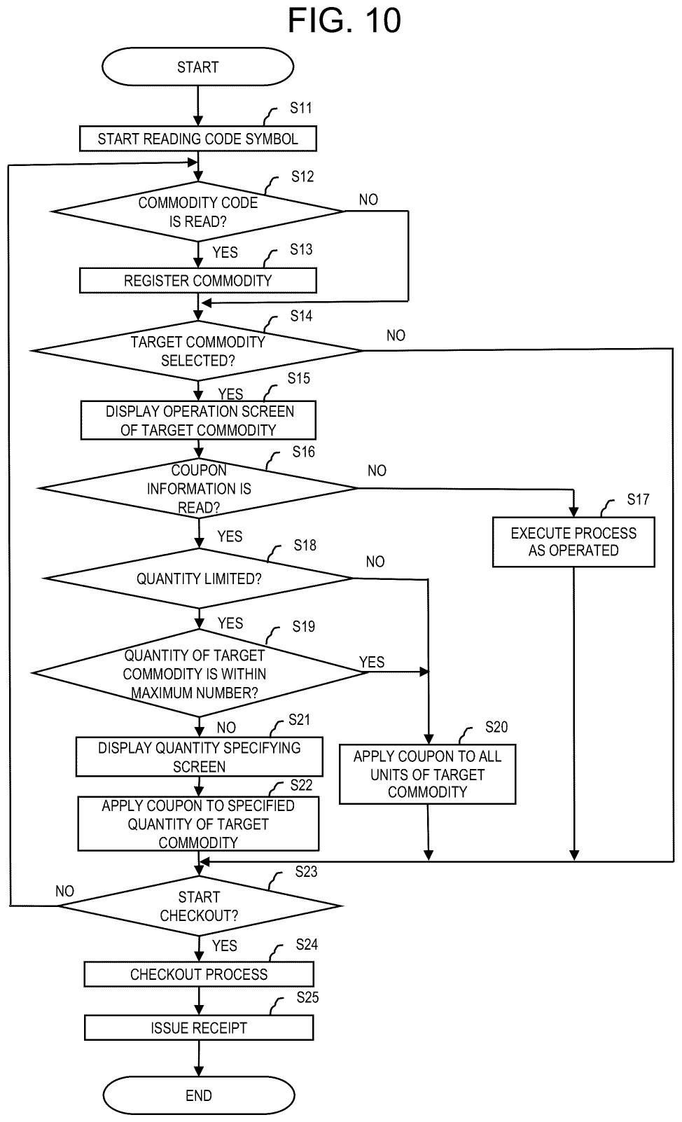

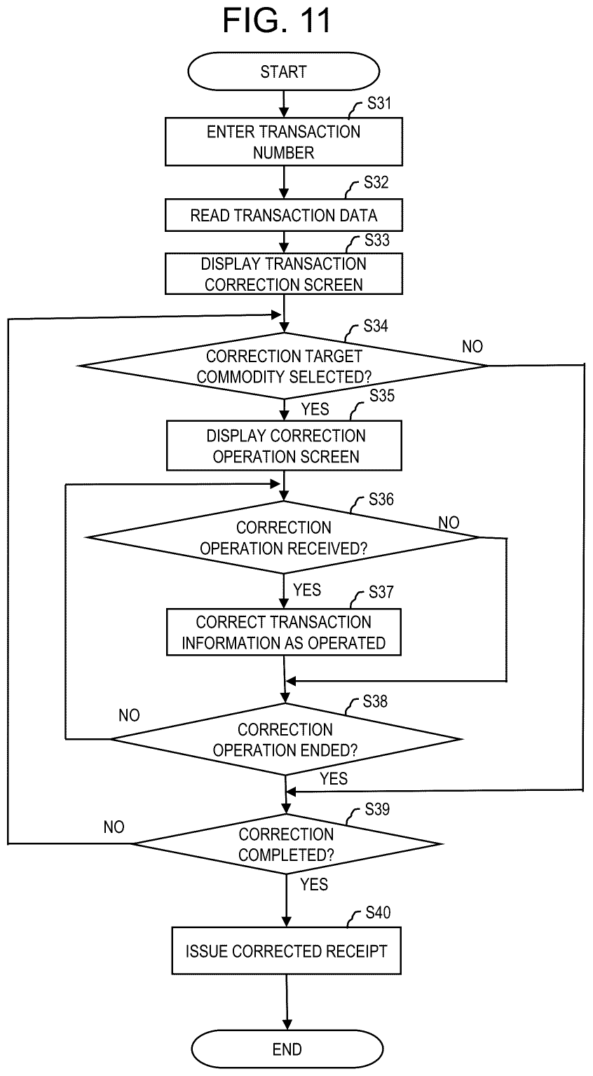

Next, referring to FIG. 10 and FIG. 11, an exemplary operation of the POS terminal 1 is described.

First, referring to FIG. 10, an exemplary commodity registration and checkout process performed by the POS terminal 1 is described. FIG. 10 is a flowchart of a commodity registration and checkout process performed by the POS terminal 1.

The reading control unit 101 starts reading a code symbol by operating the reading unit 19 in response to an instruction to start a transaction (step S11). Further, the display control unit 103 causes the display unit 17 to display the commodity registration screen GA in response to the instruction to start the transaction.

When the commodity code is read by the reading control unit 101 (step S12; Yes), the registration processing unit 102 reads the commodity information of the commodity corresponding to the commodity code from the commodity master 142. Next, the registration processing unit 102 registers the read commodity information together with the commodity code, the quantity, and the like in the RAM 13 as registration data of the commodity constituting transaction data of one transaction (step S13), and proceeds to step S14. When the reading control unit 101 does not read the commodity code (step S12; No), the registration processing unit 102 proceeds to step S14.

Subsequently, the display control unit 103 determines whether an operation for selecting a target commodity from among registered commodities has been received (step S14). Here, when the operation for selecting a target commodity is not received (step S14; No), the display control unit 103 proceeds to step S23.

In addition, when the selection operation of the target commodity is received (step S14; Yes), the display control unit 103 causes the display unit 17 to display the operation screen GB showing the registered information of the target commodity (step S15). Next, the coupon application unit 104 determines whether coupon information has been read by the reading control unit 101 (step S16). Here, when the coupon information has not been read (step S16; No), for example, when an operation element displayed on the operation screen GB is operated, the control unit 100 (i.e., the registration processing unit 102 or the like) executes a process corresponding to the operated operation element (step S17), returns the display to the commodity registration screen GA, and then proceeds to step S23.

When the coupon information is read at step S16 (step S16; Yes), the coupon application unit 104 determines whether the coupon information includes quantity limiting information specifying the maximum number of units of the target commodity to which the coupon is applicable (step S18). When the quantity limiting information is not included (step S18; No), the coupon application unit 104 applies the coupon to all units of the target commodity (step S20), and proceeds to step S23.

When the coupon information includes the quantity limiting information (step S18; Yes), the coupon application unit 104 compares the number of units of the target commodity with the maximum number of units specified in the coupon information, and determines whether the number of units is less than or equal to the maximum number of units (step S19). Here, when the number of units of the target commodity is less than or equal to the maximum number of units (step S19; Yes), the coupon application unit 104 applies the coupon to all units of the target commodity (step S20), and proceeds to step S23.

On the other hand, when the number of units of the target commodity is greater than the maximum number of units (step S19; No), the display control unit 103 causes the display unit 17 to display the quantity specifying screen GC for specifying the number of units of the commodity to which the reward of the coupon information is to be applied (step S21). When the number of units is specified on the quantity specifying screen GC, the coupon application unit 104 applies the coupon to the specified number of units of the target commodity (step S22), and proceeds to step S23.

Along with the process of step S22, the registration processing unit 102 classifies multiple units of the target commodity into coupon-applied units to which the reward is applied and coupon-not-applied units to which the reward is not applied and reregisters registration data of the coupon-applied units and the coupon-not-applied units. Note that, in the registration data of the coupon-applied units, a discount value used as the reward is additionally registered as information indicating that the coupon has been applied. In addition, along with the process of step S22, the display control unit 103 separately displays information related to the coupon-applied-units and information related to the coupon-not-applied units on the quantity specifying screen GC.

Subsequently, the checkout processing unit 105 determines whether an instruction to start the checkout process has been received (step S23). Here, when the instruction to start the checkout process has not been received (step S23; No), the checkout processing unit 105 returns to step S12. In contrast, when receiving the instruction to start the checkout process (step S23; Yes), the checkout processing unit 105 executes the checkout process of settling the total price of the registered commodities with the payment amount paid by the customer based on the transaction data of one transaction registered so far (step S24).

Then, when the checkout process is completed, the checkout processing unit 105 issues a receipt on which the transaction number of the transaction and the details of the transaction are printed (step S25), and ends the process. Note that the reading control unit 101 may stop the operation of the reading unit 19 upon completion of the checkout process.

Next, referring to FIG. 11, an exemplary process of correcting a transaction performed by the POS terminal 1 is described. FIG. 11 is a flowchart of a transaction correcting process performed by the POS terminal 1.

When receiving an input of a transaction number via the operating unit 18 (step S31) after an operation for instructing the start of a transaction correction process is performed, the transaction correction unit 106 reads transaction data corresponding to the transaction number from the transaction management file 143 (step S32).

Next, the display control unit 103 causes the display unit 17 to display, based on the transaction data read at step S32, the transaction correction screen GD that enables selection of a correction target commodity from among the commodities included in the transaction data (step S33).

Subsequently, the display control unit 103 determines whether a correction target commodity has been selected (step S34). Here, when the correction target commodity has not been selected, the process proceeds to step S39. On the other hand, when the correction target commodity has been selected (step S34; Yes), the display control unit 103 causes the display unit 17 to display the correction operation screen GE for correcting the transaction information of the correction target commodity (step S35).

Next, the transaction correction unit 106 determines whether a correction operation for correcting the transaction information has been received (step S36). When the correction operation has not been received, the transaction correction unit 106 proceeds to step S38. When the correction operation has been received (step S36; Yes), the transaction correction unit 106 executes a correction process for correcting the transaction information of the correction target commodity according to the correction operation (step S37), and proceeds to step S38.

For example, when the discount amount or the discount rate is corrected, the transaction correction unit 106 corrects the discount amount or the discount rate of the correction target commodity included in the transaction data to a changed value, and corrects the subtotal price of the correction target commodity and the total price of all the commodities. Further, for example, when the number of units of the commodity to which the reward of the discount value is applied is corrected, the transaction correction unit 106 corrects the number of units of the correction target commodity included in the transaction data to the corrected value, and corrects the subtotal price of the correction target commodity and the total price of all the commodities.

Subsequently, the transaction correction unit 106 determines whether to end the correction operation of the correction target commodity (step S38). Here, when the termination of the correction operation is not instructed (step S38; No), the transaction correction unit 106 returns to step S36. When the termination of the correction operation is instructed (step S38; Yes), the transaction correction unit 106 clears the correction operation screen GE and determines whether the correction process is completed (step S39).

When the termination of the correction process is not instructed (step S39; No), the transaction correction unit 106 returns to step S34. When the termination of the correction process is instructed (step S39; Yes), the transaction correction unit 106 issues a corrected receipt based on the corrected transaction data (step S40), and then ends the present process.

As described above, the POS terminal 1 registers the commodity codes of commodities purchased by the customer in association with the quantities of the commodities. Further, when receiving an operation to select a target commodity to which a coupon is to be applied from among the registered commodities, the POS terminal 1 determines whether the number of units (quantity) of the target commodity is less than or equal to the maximum number of units to which the coupon is applicable. When the number of units of the target commodity is less than or equal to the maximum number of units, the POS terminal 1 applies the coupon to all units of the target commodity. When the number of units of the target commodity is greater than the maximum number of units, the POS terminal 1 receives an operation to specify the number of units of the target commodity to which the coupon is to be applied, and applies the coupon to the specified number of units of the target commodity when the specified number of units is less than or equal to the maximum number of units.

Accordingly, even when a coupon presented by the customer is a quantity limited coupon, the POS terminal 1 can apply the coupon by limiting the number of units of the commodity to which the reward is applied to a value less than or equal to the maximum number of units specified in the quantity limited coupon. Therefore, the POS terminal 1 can appropriately use a coupon that is applicable to a limited number of units of a commodity.

The above-described embodiment can be modified and implemented as appropriate by changing a part of the configuration or function of the above-described POS terminal 1. Therefore, in the following, some modifications according to the above-described embodiment are described as other embodiments. In the following, differences from the above-described embodiment are mainly described, and detailed descriptions of the same points as those described above are omitted. Further, the modification examples described below may be implemented individually or in combination as appropriate.

(Modification 1)

In the above-described embodiment, the selection of a target commodity is performed by the operator of the POS terminal 1. However, the present invention is not limited to this example, and a target commodity may be automatically selected.

When the above modification is adopted, for example, coupon information may include in advance the commodity code of a commodity to which the coupon is applied. Accordingly, when the coupon information is read, the coupon application unit 104 can automatically select a commodity corresponding to the commodity code included in the coupon information as the target commodity from among registered commodities.

(Modification 2)

In the above-described embodiment, the POS terminal 1 locally stores the commodity master 142 and the transaction management file 143. However, the present invention is not limited to this example, and the POS terminal 1 may be configured to refer to or operate the commodity master 142 and the transaction management file 143 stored in an external device such as a server.

In the above-described embodiment, the control programs executed by the apparatuses may be stored in and copied from a non-transitory computer-readable recording medium such as a CD-ROM. Further, the control programs executed by the devices may be stored in and downloaded from a computer connected to a network such as the Internet or may be provided via a network such as the Internet.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A commodity sales data processing apparatus comprising:
an input device;
a memory; and
a processor configured to
register, in the memory and for each of commodities to be purchased, information for identifying the each of the commodities and a number of units of the each of the commodities in association with each other,
in response to a first operation that is input through the input device to select a target commodity to which a coupon is to be applied from among the commodities, determine whether the registered number of units of the target commodity is less than or equal to a maximum number of units to which the coupon is applicable,
upon determining that the registered number of units is less than or equal to the maximum number of units, apply the coupon to all of the units of the target commodity, and
upon determining that the registered number of units is not less than or equal to the maximum number of units,
in response to a second operation that is input through the input device to specify a number of units of the target commodity to which the coupon is to be applied, determine whether the specified number of units is less than or equal to the maximum number of units, and
upon determining that the specified number of units is less than or equal to the maximum number of units, apply the coupon to the specified number of units of the target commodity.

2. The commodity sales data processing apparatus according to claim 1, further comprising:
a display device, wherein
the processor is configured to cause the display device to display the each of the commodities in association with the registered number of units of the each of the commodities and information indicating whether the coupon is applied to the each of the commodities.

3. The commodity sales data processing apparatus according to claim 2, wherein
the processor is configured to cause the display device to separately display coupon-applied units of the target commodity to which the coupon is applied and coupon-not-applied units of the target commodity to which the coupon is not applied.

4. The commodity sales data processing apparatus according to claim 3, wherein
the processor is configured to, after determining that the registered number of units is not less than or equal to the maximum number of units, cause the display device to display an operation screen for specifying the number of units of the target commodity to which the coupon is to be applied.

5. The commodity sales data processing apparatus according to claim 4, wherein
the operation screen indicates a number of units less than or equal to the maximum number of units.

6. The commodity sales data processing apparatus according to claim 1, further comprising:
a reading device configured to read, from a code symbol, coupon information including a reward to be applied by the coupon and the maximum number of units, wherein
the processor is configured to compare the registered number of units of the target commodity with the maximum number of units based on the coupon information read by the reading device.

7. The commodity sales data processing apparatus according to claim 1, wherein
the processor is configured to determine whether the coupon is a quantity limited coupon that includes information indicating the maximum number of units to which the coupon is applicable.

8. The commodity sales data processing apparatus according to claim 1, wherein
the coupon includes information indicating a discount value, and
the processor is configured to
calculate a subtotal price of coupon-applied units of the target commodity to which the coupon is applied based on a unit price of the target commodity to which the discount value is applied, and
calculate a subtotal price of coupon-not-applied units of the target commodity to which the coupon is not applied based on the unit price of the target commodity to which the discount value is not applied.

9. The commodity sales data processing apparatus according to claim 1, wherein
the processor is configured to register, in the memory, transaction data including a commodity code, a commodity name, a unit price, a number of units, a discount value, and a subtotal price of the each of the commodities.

10. The commodity sales data processing apparatus according to claim 1, further comprising:
a display device, wherein
the processor is configured to cause the display device to display a correction operation screen for correcting the specified number of units of the target commodity.

11. A non-transitory computer readable medium storing a program for causing a computer to execute a process including:
registering, in a memory and for each of commodities to be purchased, information for identifying the each of the commodities and a number of units of the each of the commodities in association with each other;
receiving a first operation to select a target commodity to which a coupon is to be applied from among the commodities;
determining whether the registered number of units of the target commodity is less than or equal to a maximum number of units to which the coupon is applicable;
upon determining that the registered number of units is less than or equal to the maximum number of units, applying the coupon to all of the units of the target commodity; and
upon determining that the registered number of units is not less than or equal to the maximum number of units,
receiving a second operation to specify a number of units of the target commodity to which the coupon is to be applied,
determine whether the registered number of units is less than or equal to the maximum number of units, and
upon determining that the specified number of units is less than or equal to the maximum number of units, applying the coupon to the specified number of units of the target commodity.

12. The non-transitory computer readable medium according to claim 11, wherein the process further includes
causing a display device to display the each of the commodities in association with the registered number of units of the each of the commodities and information indicating whether the coupon is applied to the each of the commodities.

13. The non-transitory computer readable medium according to claim 12, wherein the process further includes
causing the display device to separately display coupon-applied units of the target commodity to which the coupon is applied and coupon-not-applied units of the target commodity to which the coupon is not applied.

14. The non-transitory computer readable medium according to claim 13, wherein the process further includes
after determining that the registered number of units is not less than or equal to the maximum number of units, causing the display device to display an operation screen for specifying the number of units of the target commodity to which the coupon is to be applied.

15. The non-transitory computer readable medium according to claim 14, wherein the operation screen indicates a number of units less than or equal to the maximum number of units.

16. The non-transitory computer readable medium according to claim 11, wherein the process further includes
causing a reading device to read, from a code symbol, coupon information including a reward to be applied by the coupon and the maximum number of units, and
comparing the registered number of units of the target commodity with the maximum number of units based on the coupon information read by the reading device.

17. The non-transitory computer readable medium according to claim 11, wherein the process further includes
determining whether the coupon is a quantity limited coupon that includes information indicating the maximum number of units to which the coupon is applicable.

18. The non-transitory computer readable medium according to claim 11, wherein
the coupon includes information indicating a discount value, and
the process further includes
calculating a subtotal price of coupon-applied units of the target commodity to which the coupon is applied based on a unit price of the target commodity to which the discount value is applied, and
calculating a subtotal price of coupon-not-applied units of the target commodity to which the coupon is not applied based on the unit price of the target commodity to which the discount value is not applied.

19. The non-transitory computer readable medium according to claim 11, wherein the process further includes
registering, in the memory, transaction data including a commodity code, a commodity name, a unit price, a number of units, a discount value, and a subtotal price of the each of the commodities.

20. A method of processing commodity sales data, comprising:
registering, in a memory and for each of commodities to be purchased, information for identifying the each of the commodities and a number of units of the each of the commodities in association with each other;
receiving a first operation to select a target commodity to which a coupon is to be applied from among the commodities;
determining whether the registered number of units of the target commodity is less than or equal to a maximum number of units to which the coupon is applicable;
upon determining that the registered number of units is less than or equal to the maximum number of units, applying the coupon to all of the units of the target commodity; and
upon determining that the registered number of units is not less than or equal to the maximum number of units,
receiving a second operation to specify a number of units of the target commodity to which the coupon is to be applied,
determine whether the registered number of units is less than or equal to the maximum number of units, and
upon determining that the specified number of units is less than or equal to the maximum number of units, applying the coupon to the specified number of units of the target commodity.
